(19) United States
(12) Patent Application Publication
(10) Pub. No.: US 2006/0108890 A1
(43) Pub. Date: May 25, 2006

(54) Stator arrangement for an electric machine, a method for the manufacture of a stator arrangement and a direct current motor

(76) Inventors: Willi Hauger, Villingen-Schwennigen (DE); Helmut Ganter, Bad Durrheim (DE)

Correspondence Address: Mark C. Comtois;DUANE MORRIS LLP, Suite 700, 1667 K Street, N.W., Washington, DC, 20006, US

(21) Appl. No.: 11/259,277

(22) Filed: Oct. 27, 2005

(30) Foreign Application Priority Data
Aug. 1, 2005 (EP) 05 016 715.4
Nov. 22, 2004 (DE) 10 2004 056 303.9

(51) Int. Cl. H02K 3/48; H02K 1/12

(52) U.S. Cl. 310/214; 310/254

(57) ABSTRACT

The invention relates to a stator arrangement for an electric machine, particularly a DC motor, comprising a stator body having a stator back yoke ring and a number of stator teeth between which stator slots to receive stator windings are formed, the stator teeth extending radially from the stator back yoke ring and stator poles being formed at the free ends of the stator teeth, the stator teeth being coupled to a sleeve, which extends coaxially to the stator body, at their free ends. The invention also relates to a method for the manufacture of a stator arrangement of this kind and a direct current motor that employs such a stator arrangement.

### FIELD OF THE INVENTION

The invention relates to a stator arrangement for an electric machine, a method for the manufacture of a stator arrangement and a direct current motor that employs a stator arrangement of this kind. The stator arrangement according to the invention can be employed in many different types of electric machines and is particularly intended for DC motors and generators.

### BACKGROUND OF THE INVENTION

A preferred field of application for the invention is in brushless DC motors and other permanent magnet motors that are preferably configured as inner rotor motors. Electric motors having a permanently magnetic inner rotor motor configuration have a rotor back yoke that is mounted onto a shaft, one or more permanent magnets being mounted onto the rotor back yoke or embedded in the back yoke. The motors additionally comprise a stator arrangement typically consisting of a number of stacked metal laminations which form an annular stator back yoke from which stator teeth protrude radially inwards. The stator teeth form the stator poles between which stator slots, for receiving stator windings, are formed. The rotor arrangement is inserted coaxially into the stator arrangement. The invention also finds application in outer rotor motors.

It is common for the rotor and the stator to be accommodated in a housing that has at least one end flange for the purpose of fastening the motor. However, motors are also known in which the outer surface of the stator lamination stack seals the motor to the outside. In most motors, the stator is made up of a slotted stack of laminations, the stator windings, made, for example, from insulated copper wire, being accommodated in the stator slots. The stator teeth are normally widened at their free end and form pole shoes whose purpose is to absorb as much magnetic flux as possible and, through their design, to reduce the cogging torque of the machine. The pole shoes take on the additional function of fixing the windings in position within the slots. In order to minimize the cogging torque of an electric machine and to optimize the magnetic flux, the pole shoes should be as wide as possible. A disadvantage of wide pole shoes, however, is that they only leave a relatively narrow gap open in the stator slots through which the winding wire is led.

It is thus the object of the invention to provide a stator arrangement for an electric machine that shows good properties with respect to magnetic flux conduction and cogging torque and nevertheless allows a simple winding process for the stator teeth.

### SUMMARY OF THE INVENTION

This object has been achieved by a stator arrangement having the characteristics outlined in patent claim 1. The invention also provides a DC motor according to claim 11 as well as a method for the manufacture of a stator arrangement for an electric machine according to claim 12.

The invention provides a stator arrangement for an electric machine, and particularly for a DC motor, which has a stator body having a stator back yoke ring and a plurality of stator teeth. The stator teeth extend from the stator back yoke ring in a radial direction and define stator slots to receive the windings in between each other. Stator poles are formed on the free ends of the stator teeth. In its preferred embodiment of the invention, the stator arrangement is designed for an inner rotor motor, the stator teeth in this configuration extending radially inwards from the stator back yoke ring. The stator teeth do not have any widened pole shoes at their free ends, as would normally be expected in the prior art. The slot openings between the stator teeth are thus wide, making it significantly easier to insert the winding wire into the slot openings to wind the stator teeth than is the case for conventional stator arrangements for inner rotor motors. After the stator teeth have been wound, a sleeve is mounted onto the stator arrangement according to the invention, the sleeve extending coaxially to the stator body and being coupled to the free ends of the stator teeth. In an inner rotor configuration, the sleeve defines the inside diameter of the stator and seals the stator with respect to the rotor.

In the stator arrangement according to the invention, the sleeve takes on several functions. Firstly, it acts as a slot cover and holds the windings in the stator slots. For this function, it is expedient if the sleeve is given a coating of an electrically insulating material on its surface facing the stator slots, so that it also takes on the function of insulating the slots. Another, more important function of the sleeve is to form pole shoes. To this effect, it is expedient if the sleeve is made of a ferromagnetic material and is magnetically coupled to the free ends of the stator teeth. Moreover, the sleeve is preferably designed in such a way that it has non-magnetic or low-magnetic zones between two adjoining stator teeth that extend in an axial direction in order to separate the pole shoes of adjoining stator teeth from one another. These zones between the pole shoes can be narrow since they merely have the function of magnetically isolating the pole shoes from one another. This provides a stator arrangement that has particularly wide pole shoes which is advantageous for the running performance of the electric machine and, in particular, makes it also possible to reduce cogging torque.

In a first embodiment of the invention, the zones to separate the pole shoes are formed by small slits that are die-cut into the sleeve, for example. In this embodiment, the sleeve is preferably made of a ferromagnetic material.

In another embodiment of the invention, the sleeve is made of a bi-permeable material that is ferromagnetic in a first state and paramagnetic in a second state. In its original state, this material has ferromagnetic properties and after heat treatment it takes on paramagnetic properties. In the region in which the non-magnetic or low-magnetic zones are to be created, the sleeve is locally heated and thus transformed into its paramagnetic state in these zones.

A material that is suitable for the manufacture of the sleeve according to the invention is an alloy based on Fe—Cr—C that is made by Hitachi Metals Ltd., Tokyo, Japan under the name YEP FA1 steel. This alloy is described, for example, in U.S. Pat. Nos. 6,255,005 and 6,390,443 as well as in the Japanese Laying-open Publications JP 2004 091842, JP 2004 143585 and JP 2004 281737. Reference is made to these publications with regard to the composition of the bi-permeable material and to the temperature ranges revealed in the documents, particularly the temperatures to transform the bi-permeable material from the ferromagnetic to the paramagnetic state. In the above-mentioned publications, the bi-permeable material is used in electromagnetic valves and other magnetic components; its use in stator arrangements is neither described nor considered.

In a beneficial embodiment of the invention, the sleeve is also coated with an electrically insulating material on its surface facing away from the stator slots to provide electric insulation vis-à-vis the rotor, to prevent, for example, voltage flash-over in case of failure.

The stator arrangement according to the invention can be manufactured in a very simple and cost-effective process if the sleeve is made of stamped, rolled sheet metal that can be coated if required. In the first embodiment, the sleeve is first die-cut from flat sheet metal, slits to separate the individual pole shoes and cutouts to connect the sleeve to the stator teeth being die-cut at the same time. The sheet metal is then rolled to form a sleeve which is open at a joint and thus flexible. This makes it easier to mount or press the sleeve onto the free ends of the stator teeth. It is expedient if the free ends of the stator teeth are given a fit that engages with the cutouts in the sleeve. A variety of different sleeve designs is conceivable. For instance, the cutouts to connect the sleeve to the stator teeth could take the form of slits that extend in an axial direction along the sleeve and which are closed at both axial ends of the sleeve. In this embodiment, the cutouts are pressed onto the stator teeth. In an alternative embodiment, the cutouts are formed by slits that are only closed at one axial end of the sleeve. In this embodiment, the sleeve can be slid onto the stator body or the stator teeth respectively, in an axial direction. In another embodiment of the invention, lateral slits are formed in the stator teeth close to their free ends allowing the sleeve to be slid onto the stator teeth in an axial direction such that the edges of the cutouts engage in the slits. This has the advantage that the sleeve cannot be pulled off the stator poles as a result of the magnetic attraction of the rotor magnets. In addition or as an alternative, the sleeve can also be fixedly connected to the stator teeth by means, for example, of welding, particularly laser welding, or bonding. To give the sleeve greater stability, it could be practical to seal the joint of the rolled sleeve after it has been mounted onto the stator body. An open joint has the advantage that greater tolerances can be allowed when the sleeve is die-cut and that the sleeve is more flexible.

An embodiment of the invention is also conceivable in which the sleeve is first pressed or slid onto the stator teeth and in which the sleeve is then severed in the region of the slits separating the pole shoes in order to create pole shoes that are completely isolated from each other. To stabilize this or other embodiments of the invention, provision can also be made for the stator to be injection-molded with plastics.

In its second embodiment, the sleeve is die-cut from flat sheet metal in a similar way as in the first embodiment, the sheet metal being made of a bi-permeable material of the kind described above. Cutouts to connect the sleeve to the stator teeth are die-cut at the same time, but slits to separate the individual poles of the stator are not required. The sheet metal is then rolled to form a sleeve which is open at a joint and thus flexible. The sleeve can be slid onto the stator teeth in an axial direction or pressed onto the stator teeth. Before or after the sleeve has been mounted onto the stator teeth, preferably before the sheet metal is rolled to form a sleeve, the sleeve is locally heated within the zones that extend in an axial direction and lie between two adjacent stator teeth in order to transform the bi-permeable material within these defined zones from its original ferromagnetic state to a paramagnetic state. To this effect, the zones are preferably heated to a temperature >1150° C. using, for example, laser or induction welding. Although this second embodiment requires the additional process of locally heating the sleeve, it has the advantage of providing a sleeve with improved mechanical stability compared to the slotted sleeve. Magnetic short circuits in the region of the end face of the sleeve, where the slits of the first embodiment are bridged, can be avoided.

To stabilize the finished stator arrangement, it can be molded with a plastic or synthetic resin. Moreover, the sleeve itself can be stiffened by beading or edge bending.

Practical trials using the stator arrangement according to the invention have shown that the sleeve generates a certain proportion of eddy currents, these effects being lesser in the embodiment having the slits than in the embodiment in which the sleeve is made of the bi-permeable material. The problem of eddy current formation can be minimized by building up the sleeve from individual layers that are electrically insulated with respect to each other in a similar way as used in the production of a stator body from a stamped lamination stack. To this effect, it is preferable if a series of laminations made of a ferromagnetic material or of the bi-permeable material is stacked and die-cut into narrow metal strips. The laminations are then joined together. If the laminations are made from the bi-permeable material, it is best if the laminations are transformed into a paramagnetic state in the region of the zones by heating, using, for example, laser or induction welding, and simultaneously connected together within this region. Then the cutouts to slide the sleeve onto the stator teeth are cut out, die-cut for example, and the sleeve is rolled and joined together at its ends, if required. The advantage of this arrangement is that, due to the laminated structure, eddy currents within the sleeve material are almost totally avoided.

In a particularly preferred embodiment of the invention, at least one axial end of the sleeve projects beyond the end face of the stator body in an axial direction. This embodiment has the advantage that the bridges disposed at the axial end faces that hold the sleeve together and bridge the pole shoes, can be disposed beyond the magnetic field of the rotor. This prevents the sleeve from forming a magnetic short circuit in the region of the rotor. Another advantage of a sleeve that projects beyond at least one end face of the stator body in an axial direction is that it shields the stator magnetic fields towards the rotor. This makes particular sense for those machines in which a magnetic sensor to measure the rotational position is mounted opposite the end face of the rotor on the stator or on the flange. The shielding effect of the axially protruding sleeve means that these magnetic sensors are not influenced by the magnetic field of the stator and can thus determine the rotational position of the rotor more accurately.

### SHORT DESCRIPTION OF DRAWINGS

The invention is described in more detail below on the basis of preferred embodiments with reference to the drawings. The figures show:

FIG. 1 an external view of an electric machine according to the invention;

FIG. 2a a schematic sectional view through the electric machine of FIG. 1 along the line X-X according to a first embodiment;

FIG. 2b an enlarged detailed view of FIG. 2a;

FIG. 3 an exploded perspective view of the electric machine according to the first embodiment;

FIG. 4 a similar view as in FIG. 3 but in an assembled state; and

FIG. 5 a perspective view of a sleeve according to the first embodiment that is set into the stator arrangement according to the invention;

FIG. 6 a schematic sectional view through a part of an electric machine according to a modification of the first embodiment of the invention, which is similar to the view in FIG. 2b;

FIG. 7 an exploded perspective view of a stator arrangement according to a second embodiment of the invention;

FIG. 8 a side view of a sleeve according to the second embodiment, which is set into the stator arrangement according to the invention;

FIG. 9 a perspective view of the sleeve of FIG. 8;

FIG. 10a a perspective view of the stator arrangement according to a modification of the second embodiment of the invention; and

FIG. 10b an enlarged detailed view of FIG. 10a;

### DETAILED DESCRIPTION OF PREFERRED EMBODIMENTS

The invention is described below on the basis of an exemplary brushless DC motor, although a person skilled in the art would be aware that the principles of the invention can be applied to a large variety of electric machines, including generators.

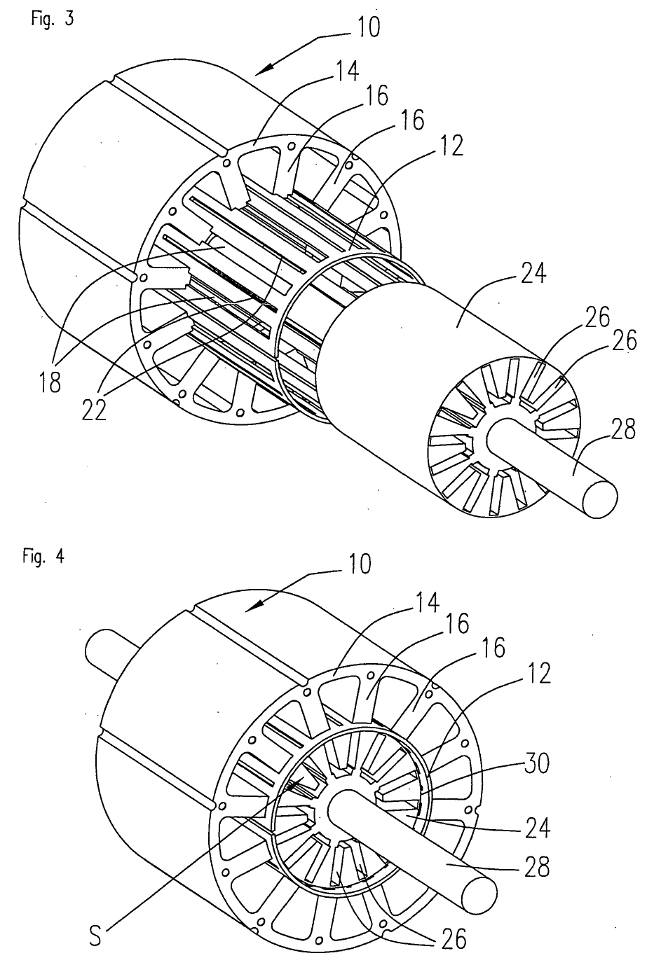

The invention is described below with reference to the figures, reference first being made to FIGS. 1 to 4.

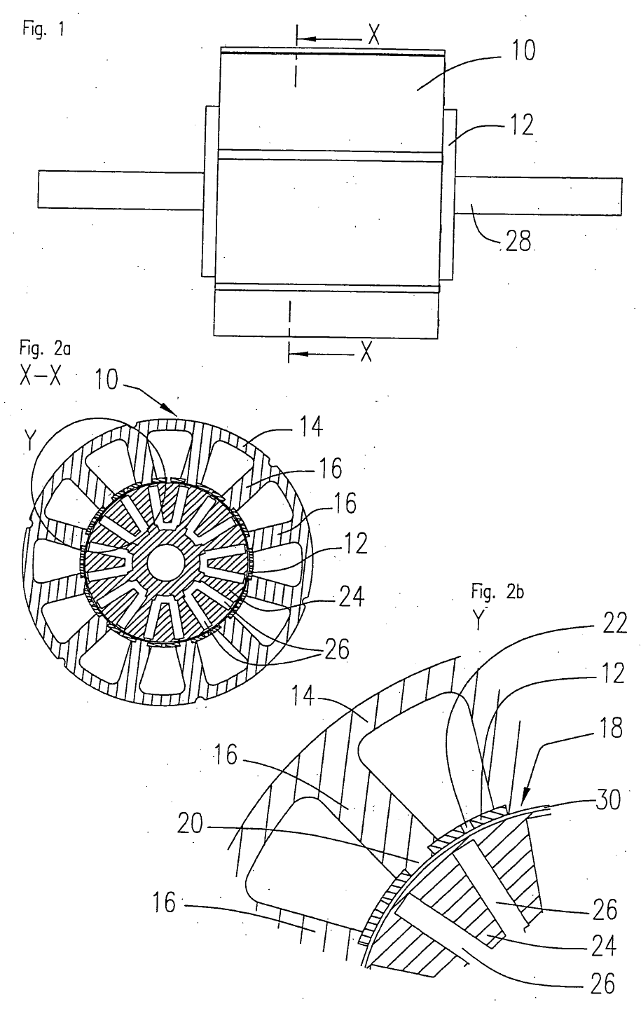

FIG. 1 shows an external view of a DC motor according to the invention. In the external view of FIG. 1, a stator body 10 can be seen in which a sleeve 12, projecting axially at both end faces of the stator body 10, is mounted on the stator teeth. As shown in FIGS. 2a, 2b, 3 and 4, the stator body 10 comprises a stator back yoke ring 14 from which stator teeth 16 project radially inwards. The stator teeth are coupled to the sleeve 12 at their free ends. The sleeve has slit-like cutouts 18 which engage with the free ends of the stator teeth 16, the stator teeth 16 in the illustrated embodiment having a connecting section 20 at their free ends that is pressed or pushed into the cutouts 18.

Moreover, the sleeve has slits 22 that are arranged approximately in the middle between two adjacent cutouts 18 or associated stator teeth 16. The sleeve can be stiffened by means of beading or edge bending (not illustrated).

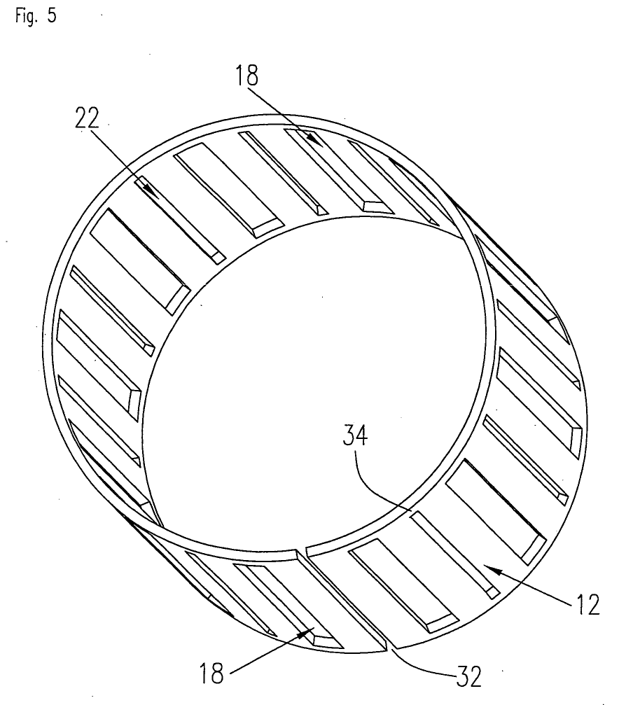

As can particularly be seen in FIGS. 1 and 4, the sleeve 12 protrudes in an axial direction with respect to the end faces of the stator body 10. It demarcates the stator body 10 with respect to a rotor area.

A rotor is arranged coaxially within the stator body 10 that is shown schematically in the figures by a rotor body 24. In the illustrated embodiment, the rotor body 24 has spoke-like recesses 26 to receive permanent magnets, the recesses 26 being connected in pairs. The rotor body 24 is mounted on a shaft 28. An air gap 30 is formed between the rotor body 24 and the stator body 10.

As illustrated in the figures, the stator teeth 16 are substantially rectangular, not being widened at their free ends as is commonly the case in the prior art in order to form pole shoes. This makes it easy to wind the stator body 10 since the slot opening between two adjacent pole teeth 16 is very wide. As an alternative, it is also possible to slide pre-wound coils together with the coil body onto the stator teeth 16 from the inside. After the stator teeth 16 have been wound, the sleeve 12 is mounted on the free ends of the stator teeth 16 and thus also acts as a slot cover. It is expedient if the sleeve 12 is coated with an electrically insulating material on its surface facing the stator slots.

In the preferred embodiment of the invention, the sleeve 12 is made of a ferroelectric material and magnetically coupled to the stator teeth. In this embodiment, the sleeve 12 forms the pole shoes at the end of the stator teeth 16, adjoining pole shoes being separated by the slits 22 formed in the sleeve. This makes it possible to produce a stator arrangement having pole shoes whose slot opening is smaller than usual in the prior art. In the known stator arrangements having molded-on pole shoes, the rule is that the slot opening has to be approximately ≧1.5 times the wire diameter that has to be inserted through the slot opening. This limitation does not apply to the stator arrangement according to the invention. This means that a stator is provided which, in operation, has extremely small torque fluctuations and a relatively high flux concentration.

The sleeve 12 is preferably so designed that it projects at the axial end faces of the stator body 10. This has the advantage that the axial bridges 34 bridging the slits 22 and necessary to hold the sleeve together, are located beyond the effective range of the rotor and thus cannot create a magnetic short circuit. Moreover, the sleeve 12 at the end face of the stator arrangement 10 shields the magnetic field generated by the stator in the direction of the rotor. The magnetic sensors located opposite the end face of the rotor for the purpose of measuring the rotational position of the electric machine, such as Hall sensors or magnetoresistive sensors, are frequently disposed on the stator or on the flange. To obtain an especially precise rotational position signal, these sensors are preferably arranged in the vicinity of the outside circumference of a rotor. This is particularly the case if the rotor does not have embedded permanent magnets (as in the illustrated embodiment) but rather permanent magnets that are arranged on the outside circumference of the rotor. However, the magnetic field generated by the winding head is also active in the vicinity of the circumference of the rotor, which, in the invention, is extensively shielded by the axially protruding sleeve 12. A possible position for a rotational position sensor is marked in FIG. 4 by the arrow S.

The sleeve 12 can be coated with an electrically insulating material on its inner surface and/or on its outer surface.

As can particularly be seen in reference to FIG. 5, the sleeve is preferably die-cut from sheet metal and then rolled, it being possible for the sleeve 12 to remain open at a joint 32. This makes the sleeve 12 flexible enough to be inserted in an axial direction into the inside of the stator body 10 and to be pressed onto the stator teeth 16 using the cutouts 18. The geometry of the free ends of the stator teeth 16 and the cutouts 18 has to be made to fit each other accordingly.

In the illustrated embodiment, the cutouts 18 and the slits 22 are bridged by bridges 34 at both axial ends of the sleeve 12. In an alternative embodiment, it can be provided that the cutouts 18 are open at one axial end of the sleeve 12. This makes it possible to slide the sleeve 12 in an axial direction onto the stator teeth 16. Moreover, provision can be made for the slits 22 as well to be open at an axial end of the sleeve which goes to minimize the risk of the sleeve 12 forming a magnetic short circuit. Provision can also be made to sever the sleeve 12 in the region of the slits 22 after it has been mounted onto the stator teeth 16 in order to completely isolate adjacent pole shoes from each other for their magnetic optimization. It can further be expedient to mold the wound stator arrangement after the sleeve 12 has been mounted with a plastic in order to increase the stability of the stator arrangement. Severing the sleeve 12 can be done after the stator arrangement has been embedded in plastic.

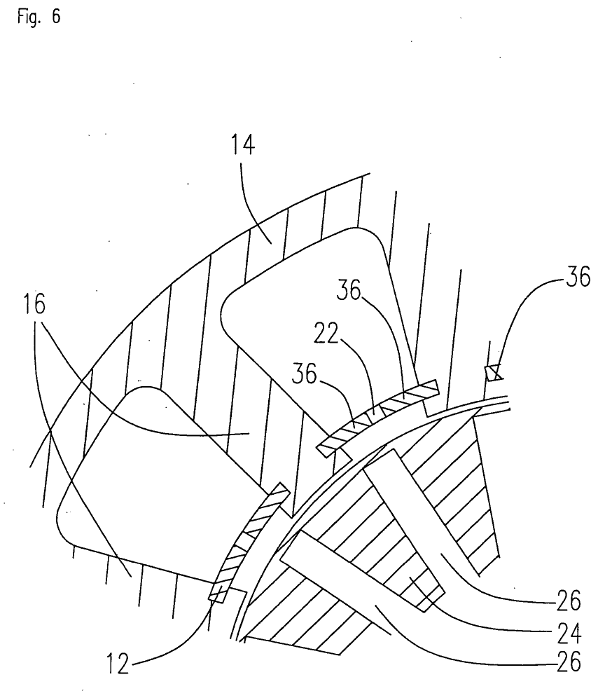

FIG. 6 shows a schematic section through a detail of an electric machine according to another embodiment of the invention, which is similar to FIG. 2b. Corresponding parts are indicated by the same reference numbers and not explained in detail again. In contrast to the embodiment described earlier, the stator teeth 16 have lateral slots 36 in the vicinity of their free ends in which the sleeve 12 can be inserted—in an axial direction of the stator. In this embodiment, the cutouts 18 in the sleeve 12 are open at an end face so that the sleeve 12 can be inserted into the slits 36 with the edges of the cutouts 18. This embodiment has the advantage that the sleeve cannot be pulled off the stator teeth or the poles as a result of the magnetic attraction of the rotor magnets.

In all embodiments of the invention, it is possible to additionally connect the sleeve 12 firmly to the stator teeth 16, for example, by welding, especially laser welding, or bonding.

The sleeve is preferably made of a magnetically conductive, i.e. ferromagnetic, material. However, if its sole function is to provide a cover for the slots, it can be made of a non-magnetic material.

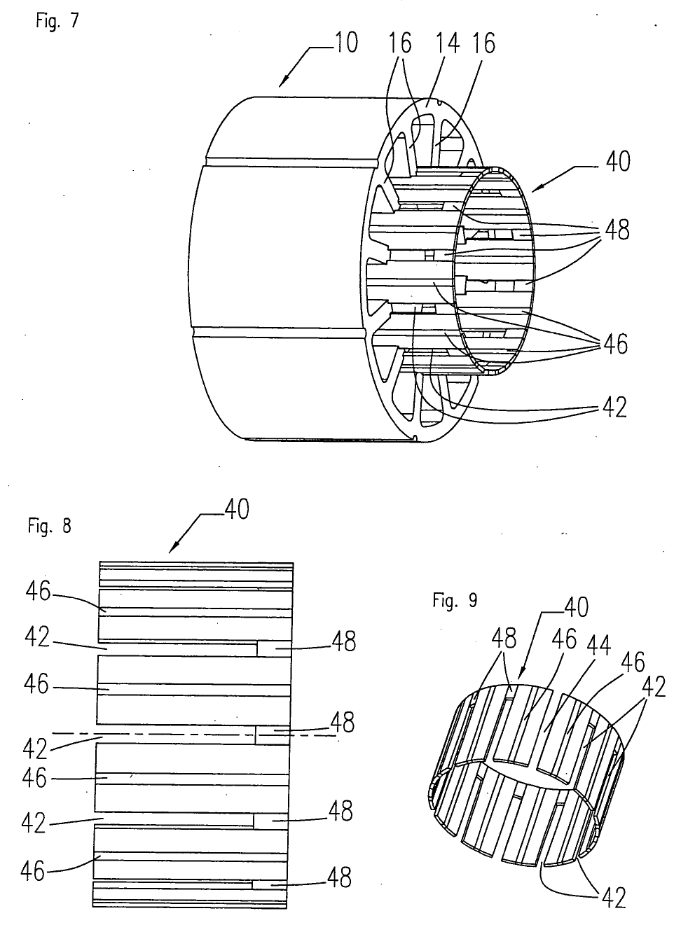

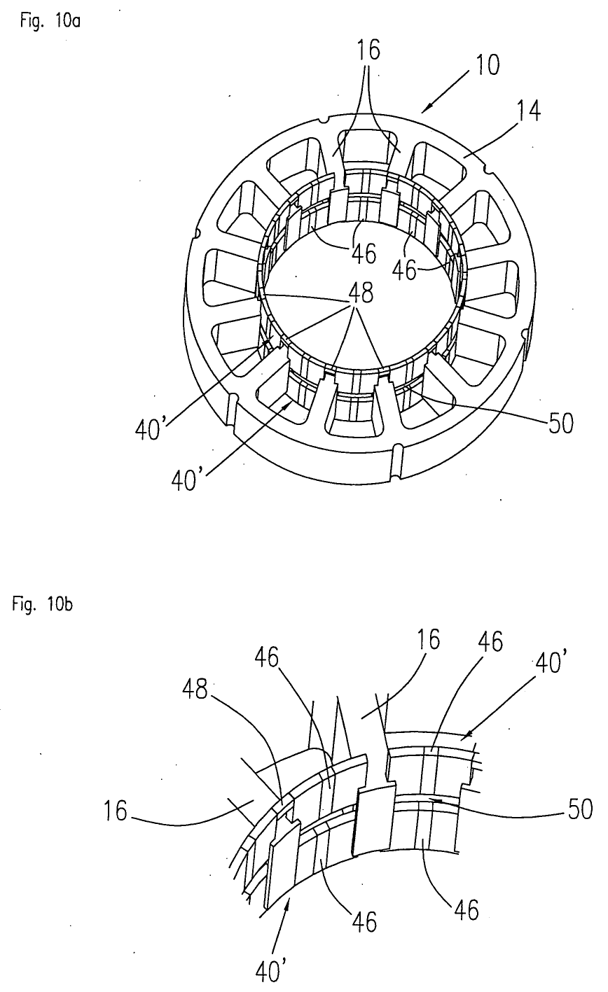

A second embodiment of the stator arrangement according to the invention is shown in FIGS. 7 to 9 and a modification of this embodiment in FIGS. 10a and 10b. As far as the stator body 10 and the rotor body 24 are concerned, this embodiment does not differ from the previously described embodiment. Corresponding parts are indicated by the same reference numbers. The sleeve, however, has a different design to the first embodiment.

In the second embodiment of the invention, the sleeve 40 is made of a magnetic material that is ferromagnetic in a first state and paramagnetic in a second state. This magnetic material is also referred to as a bi-permeable material. The preferred material for the sleeve according to the second embodiment is a YEP FA1 steel that was developed by Hitachi Metals Ltd., Tokyo, Japan. It is an alloy based on FE—Cr—C which contains additional parts of Si, Mn, Ni or Al. This material has an original ferromagnetic state having a relative magnetic permeability of approximately 900 and a paramagnetic state having a relative magnetic permeability down to some 1.01. The material can be transformed from its ferromagnetic state to a paramagnetic state by heating it to a temperature of over 1050° C., particularly over 1100° C. and preferably in the range of 1100° C. and 1200° C. A particularly preferred temperature range lies between 1150° C. and the melting point of the material. Further details are given, for example, in U.S. Pat. No. 6,255,005 as well as in the Japanese laying-open publications mentioned above.

In the second embodiment of the invention, the entire sleeve 40 is made of this material, the sleeve being preferably die-cut from sheet metal with cutouts 42 being formed during the die-cutting process. The sleeve is then rolled and can initially remain open at a joint 44. Using the cutouts 42, the sleeve 40 is slid onto the stator teeth 16 in an axial direction, as described above with reference to the first embodiment. As an alternative, the sleeve 40 can also be pressed onto the stator teeth 16.

The sleeve 40 is locally heated in the region of axially extending zones 46 transforming the sleeve 40 in the region of these zones 46 into the paramagnetic state. The zones 46 are so chosen that they provide full magnetic isolation for the individual stator poles that are formed by the stator teeth 16 and the adjoining sections of the sleeve 40, the zones 46 lying symmetrically between two adjacent stator poles.

The heat can be created by using, for example, laser or induction welding and is preferably in the order of magnitude of 1150° C. The zones 46 of the sleeve 40 can be heated either before or after the sleeve is rolled; heating preferably takes place before rolling.

As explained in reference to the first embodiment, the sleeve is preferably so designed that it protrudes at the axial end faces of the stator body 10. In the second embodiment, the bridges 48 at the end faces of the sleeve 40 that bridge the cutouts 42 and are necessary to keep the sleeve together, can also be heated and thus transformed into the paramagnetic state. This makes it possible to totally prevent short circuits in this region.

The sleeve 40 can be coated with an electrically insulating material on its inside surface.

In the illustrated embodiment, the cutouts 42 are only bridged by the bridges 48 at one axial end of the sleeve 40. In an alternative embodiment provision can be made for the cutouts 42 to be bridged at both axial ends of the sleeve 40 to give the sleeve additional stability. In this case, it would not be possible to slide the sleeve onto the stator body 10 in an axial direction but it could be pressed onto the stator teeth 16 from inside. It could be expedient to mold the wound stator arrangement with plastics after the sleeve 40 has been mounted in order to improve the stability of the stator arrangement.

In the embodiment in FIGS. 7 to 9, the sleeve 40 is slid onto the stator body 10 from one axial end of the stator body. A modification of this embodiment is shown in FIGS. 10a and 10b, the sleeve being formed in two parts in this modification so that it can be slid onto the stator body from the two opposite axial ends of the stator 10. The two halves 40′ of the sleeve can basically be constructed in exactly the same way as the single-piece sleeve 40 shown in FIGS. 8 and 9, the sleeve merely being shortened in the axial direction to allow the two halves 40′ to be slid onto the stator body from both sides in such a way that they complete each other to form a sleeve that extends substantially over the entire axial length of the stator.

While a gap 50 between the sleeve halves 40′ is shown in FIGS. 10a and 10b, the halves are preferably slid so far over the stator body 10 that they touch each other at their end faces, with a small gap being tolerable.

The second embodiment has the advantage of increased mechanical stability combined with complete magnetic isolation of the individual poles of the stator arrangement. However, it does generate a certain amount of eddy currents which can be suppressed by the measures described below.

In another modification of the invention that is not shown in the figures, the sleeve is built up of individual layers that are electrically insulated from one another. To this effect, sheet metal made of a bi-permeable material is preferably stacked and die-cut into metal strips, which are initially linear and act as a basic body for the sleeve. Then the regions that are to form the de-magnetized zones are de-magnetized by heating using, for example, laser or induction welding, and the individual laminations are simultaneously joined together by these means. The cutouts for the purpose of sliding the sleeve onto the stator teeth are cut out, for example, by die-cutting, and the sleeve is rolled and connected together at its ends if required. Due to the laminated structure of the sleeve, eddy currents within the sleeve material can be avoided.

The features revealed in the above description, the claims and the figures can be important for the realization of the invention in its various embodiments both individually and in any combination whatsoever.

### IDENTIFICATION REFERENCE LIST

10 Stator body
12 Sleeve
14 Stator back yoke
16 Stator teeth
18 Cutouts
20 Connecting section
22 Slits
24 Rotor body
26 Recesses
28 Shaft
30 Air gap
32 Joint
34 Bridges
36 Slots
40 Sleeve
40′ Sleeve halves
42 Cutouts
44 Joint
46 Paramagnetic zones
48 Bridges
50 Gap
S Sensor position

1. A stator arrangement for an electric machine, particularly a DC motor, comprising a stator body (10) having a stator back yoke ring (14) and a number of stator teeth (16) between which stator slots to receive stator windings are formed, the stator teeth (16) extending radially from the stator back yoke ring (14) and stator poles being formed at the free ends of the stator teeth (16), wherein the stator teeth (16) are coupled to a sleeve (12), which extends coaxially to the stator body (10), at their free ends.

2. A stator arrangement according to claim 1, wherein the sleeve (12) has non-magnetic or low-magnetic zones between two adjoining stator teeth (16) that extend in an axial direction.

3. A stator arrangement according to claim 2, wherein the sleeve (12) is made of a ferromagnetic material and the zones are formed by slits (22).

4. A stator arrangement according to claim 2, wherein the sleeve is made of a bi-permeable material whose original state is ferromagnetic and the non-magnetic or low-magnetic zones are formed by locally heating this material.

5. A stator arrangement according to claim 2, wherein the sleeve forms pole shoes at the free ends of the stator teeth (16).

6. A stator arrangement according to claim 3, wherein the sleeve forms pole shoes at the free ends of the stator teeth (16).

7. A stator arrangement according to claim 1, wherein the sleeve (12) is coated with an electrically insulating material on its surface facing the stator slots and/or on its surface facing away from the stator slots.

8. A stator arrangement according to claim 1, wherein the sleeve (12) is made of stamped, rolled sheet metal.

9. A stator arrangement according to claim 1, wherein cutouts (18) to connect the sleeve to the stator teeth (16) are formed in the sleeve (12).

10. A stator arrangement according to claim 9, wherein lateral slots (36) are formed in the stator teeth (16) in which the sleeve (12) is held.

11. A stator arrangement according to claim 9, wherein the cutouts (18) are open at one end face of the sleeve (12) in order to axially slide the sleeve onto the stator teeth (16).

12. A stator arrangement according to claim 1, wherein at least one axial end of the sleeve (12) projects beyond an end face of the stator body (10) in an axial direction.

13. A DC motor having a stator arrangement comprising comprising a stator body (10) having a stator back yoke ring (14) and a number of stator teeth (16) between which stator slots to receive stator windings are formed, the stator teeth (16) extending radially from the stator back yoke ring (14) and stator poles being formed at the free ends of the stator teeth (16), wherein lateral slots (36) are formed in the stator teeth (16) in which the sleeve (12) is held, wherein a rotor (24) is coaxially inserted in the stator body (10) and a rotational position sensor is disposed opposite an end face of the rotor (24) radially within the axially protruding sleeve (12).

14. A method for the manufacture of a stator arrangement for an electric machine, particularly a DC motor, comprising the steps of:
providing a stator body (10) having a stator back yoke ring (14) and a number of stator teeth (16) between which stator slots to receive stator windings are formed, the stator teeth (16) extending radially from the stator back yoke ring (14) and stator poles being formed at the free ends of the stator teeth (16),
providing the stator body (10) with phase windings and
connecting the stator teeth (16) to a sleeve (12), which extends coaxially to the stator body (10), at their free ends.

15. A method according to claim 14, wherein the sleeve (12) is separated into individual pole shoes after being mounted onto the stator teeth (16),

16. A method according to claim 14, wherein the sleeve is made of a bi-permeable material alloy which is ferromagnetic in an original state and that before or after being connected to the stator teeth, the sleeve is locally heated within zones extending in an axial direction and lying between two adjacent stator teeth in order to transform the bi-permeable material within these zones into a paramagnetic state.

17. A method according to claim 14, wherein the stator arrangement is molded with a plastic or a synthetic resin after the sleeve (12) has been mounted.

18. A method according to claim 14, wherein the sleeve is slid axially onto the stator teeth (16).
